(19) United States
(12) Patent Application Publication
(10) Pub. No.: US 2012/0042394 A1
(43) Pub. Date: Feb. 16, 2012

(54) System and method for alerting on open file-share sessions associated with a device

(76) Inventor: Gabriel Jakobson, Las Vegas, NV (US)

(21) Appl. No.: 13/194,546

(22) Filed: Jul. 29, 2011

Related U.S. Application Data
(63) Continuation of application No. 12/456,614, filed on Jun. 19, 2009, now abandoned.
Application No. 12/456,614 is a continuation-in-part of application No. 11/354,436, filed on Feb. 15, 2006, now Pat. No. 7,581,004.

(51) Int. Cl. G06F 21/24

(52) U.S. Cl. 726/29

(57) ABSTRACT

A method and system for detecting an active file-share session on a monitored device associated with a client device, alerting the user of the client device, and enabling them to terminate the file-share session, are disclosed. In accordance with the disclosed method and system, when a remote device (e.g., on a network, the internet, etc.) connects to a shared file or folder on a monitored device (e.g., a personal computer, network area storage, a game console, a storage area network, a smart telephone, etc.) the user of the client device receives an immediate, automatic alert with the specifics of the file-sharing session and data affected. The user is then presented with an option of whether to OK the file-sharing session (i.e. allow data access to proceed), or to disconnect the file-share session (i.e. cause the remote user to lose access to the monitored device's shared data).

### RELATED U.S. APPLICATION DATA

Continuation-in-Part of application Ser. No. 11/354,436, filed on Feb. 15, 2006.

### FIELD OF INVENTION

The present invention generally relates to the sharing of files and folders among devices on a network; and, more particularly, to providing a device user with an alert, in real time, indicating a file or folder associated with their device is being accessed by a remote device as part of a file-sharing session; and, allowing the user to quickly terminate that file-sharing session from their device.

### BACKGROUND OF THE INVENTION

With nearly all electronic devices today connected to some sort of network—home, work or internet—the need to protect one's information associated with—or accessible to—one's computer or device is stronger than ever. Individual devices join networks quickly and seamless, with the mere act of turning on a laptop in more and more public places may automatically join that laptop to a network with thousands of other users. A network is designed to be a collaborative environment, so the means of making one's files accessible to others, are at the core of all operating systems.

Data stored on a user's device, as well as on devices associated with, or accessible to the user's device, is vulnerable to unauthorized access. It is the objective of the present invention to allow a user to be alerted of access to data associated with their device.

Various “defense strategies” to meet this challenge are on the market; however, none provides the functionality of the present invention. Below are some examples of prior-art solutions to address some of the challenges the present invention solves, and some reasons that these solutions do not meet the requirements set forth by the present invention.

Storage devices often require user authentication to access data. However, setting up granular user rights for every user on a trusted network (example a home local area network also know as a “LAN”) and matching the user rights to every type of data is usually impractical. For example, a home environment may contain a handful of users on devices ranging from PCs to game consoles to iPhones® and other smart phones. A home network-area storage (“NAS”) may contain terabytes of data such as hundreds of movies, thousands of songs, tens-of-thousands of documents and other data. Setting up user permissions on the NAS allowing a Child A to access only some specific movies and music while allowing a Child B to access another set of media and data—all while Child A and Child B and the rest of the family may be logged into a hodgepodge of electronic devices under different user names; and while gigabytes of new data (e.g. new movies and music) are added daily—is a daunting task for an entire IT organization, let alone a working parent.

Another defense layer is provided by firewalls and similar groups of products. Firewalls fail to meet the objectives of the present invention, in part because the problem they were designed to solve is to keep remote users from getting into one's device—not inform a user on what share sessions remote users have opened on his/her device, or on a device associated with the user's device. Firewalls create a division between “my device” and “the outside world”. Traffic from the “outside world” to “my device” is intercepted at the packet level and, based on the originating address of the packet and the port it is to be delivered to, the traffic is either blocked or allowed to continue. In an aggressive firewall mode, where sharing traffic is blocked, users who are trying to legitimately access shared files on a given device are blocked. These users are not challenged by a password mechanism and are not asked what resources on the host device they would like to access—their access requests are summarily denied. In a non-aggressive mode, the firewall allows traffic in and for shares to be accessed, but offers the user of the host device—the one whose files are being accessed—no further real-time information on what local files and folders are being accessed remotely, and by whom.

An ever-increasing amount of data is stored on electronic devices external to a person computer. For example, in a home environment, data such as movies and other types of media—as well as documents and financial data—are stored in external hard-drives and DVD players, NAS, game consoles and other devices. These external devices are typically accessible to users on a local network (“LAN”). With most LANs being wireless, the data may become vulnerable to access from external user (e.g. neighbors). A computer may inadvertently bridge two networks, compromising the data. For example, a home computer may be on a home LAN, having access to the data on shared devices at home; and at the same time, have access to the internet and offer some level of access to external users. External users able to access the home computer over the internet may gain access to the data on the storage devices at home, also accessible to the home computer.

No single prior art, nor a combination of prior art solves the problem addressed by the present invention: providing a user of a device with real-time alerts when any data associated with their device is accessed by remote users; and, allowing the user to quickly terminate the remote users' access to the data.

### DESCRIPTION OF THE DRAWINGS

For a more complete understanding of the present invention and further advantages thereof, references are now made to the following Detailed Description, taken in conjunction with the drawings, in which:

FIG. 1 is a block diagram of the general system architecture allowing for file-sharing alerts

FIG. 2 is an exemplary flowchart illustrating the operation of a system in accordance with the present invention

FIG. 3 is a generalized block diagram illustrating an alert message displayed to a user in response to the detection of a file-share session, according to one preferred embodiment.

FIG. 4 is a generalized block diagram illustrating monitoring storage associated with a monitored device by a client device, according to one embodiment of the present invention.

FIGS. 5A, 5B and 5C are generalized flow diagrams illustrating various ways in which a client device may interact with a monitored device to detect data access by a remote device, according to various embodiments of the present invention.

### SUMMARY OF THE INVENTION

A method and system for detecting an active file-share session associated with a client device, alerting the user of the client device, and enabling them to terminate the file-share session, are disclosed. In accordance with the disclosed method and system, when a remote computer (e.g., on a network, the internet, etc) connects to a shared file or folder (e.g. data residing on the client's electronic device, on a gaming device, on a network area storage (“NAS”) or storage area network (“SAN”) or any other storage medium on—or associated with—the client device) the user of the client device receives an immediate, automatic alert with the specifics of the file-sharing session established through this connection. The user is then presented with an option of whether to OK this file-sharing session, or to disconnect it (i.e. cause the remote user to lose access to the files or data).

### DETAILED DESCRIPTION

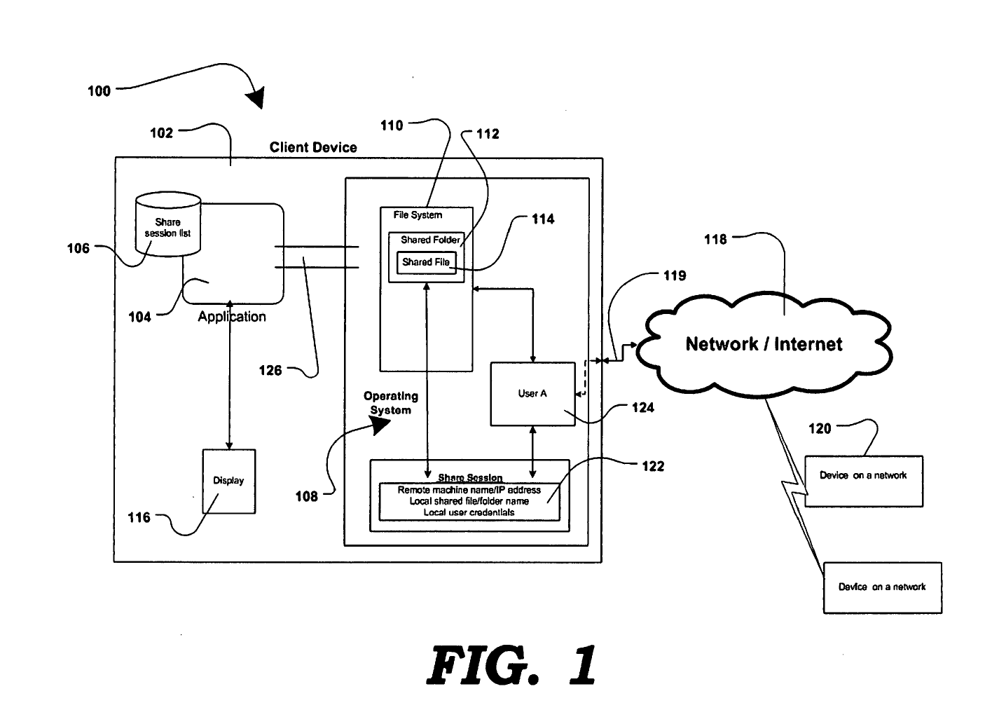

FIG. 1 illustrates a block diagram of the general system architecture of one embodiment of a file-sharing alert system 100 in accordance with the present invention. The system 100 includes a client-side application program 104 that is installed and executed on a client device 102 which is connected to one or more networks 118 through which other computers 120 may request to share files 114 and folders 112 on said client device 102.

In the embodiment illustrated herein, client device 102 comprises an operating system 108 which interacts with a file system 110 which comprises one or more shared folders 112 each comprising one or more shared files 114. Files 114 and folders 112 are accessible to local user account 124. Client side application 104 obtains a list of files 114 and folders 112 which are being opened by another computer 120 on network 118 as part of a sharing session, and displays the names of files 114 and folders 112 and the name of computer 120 which is accessing them, on a display device 116 of client device 102.

In a preferred embodiment, a system timer 126 is used to invoke the querying of operating system 108 by client side application 104. The higher the frequency of timer 126 is, the more responsive the system becomes and the more “real time” the alert 116 feels. An ideal frequency for timer 126 is under 1 cycle per second. The information obtained by application 104 from operation system 108 comprises values 122: name and IP address of remote device 120 owning the current share session, name of file(s) 114 and folders(s) 112 being shared in the current share session, and the user credentials 124 under which the current session is opened.

In one embodiment of the present invention, a user viewing on display 116 of client device 102 a list of files 114 and folders 112 which are being opened by remote computer 120, may choose an option to terminate the sharing session, thereby disabling computer 120 from further opening shared files 114 and folders 112. Upon a user on client device 102 issuing such command, client-side application 104 instructs operating system 108 to terminate the sharing session which is allowing computer 120 to view and/or manipulate files 114 and folders 112.

Information pertaining to the specifics of each sharing session and the user's decision as to whether to allow or terminate said session, are written by client-sided application 104 to memory 106. In future iterations, when client-sided application 104 is informed by operating system 108 of a sharing session by computer 120 accessing files 114 and folders 112 on client device 102, client-sided application 104 can refer to memory 106 to make a determination as to whether a user on client device 102 had already been informed of this particular session, and act in accordance with the desires and instructions of said user.

For example, if user on device 102 had been alerted and informed through display 116 that computer 120 has opened a sharing session with files 114 in folders 112, and said user had determined said sharing session should be allowed to continue and said determination has been indicated in memory 106, in future detections of said sharing session, client-sided application 104 may not alert the user again of said sharing-session.

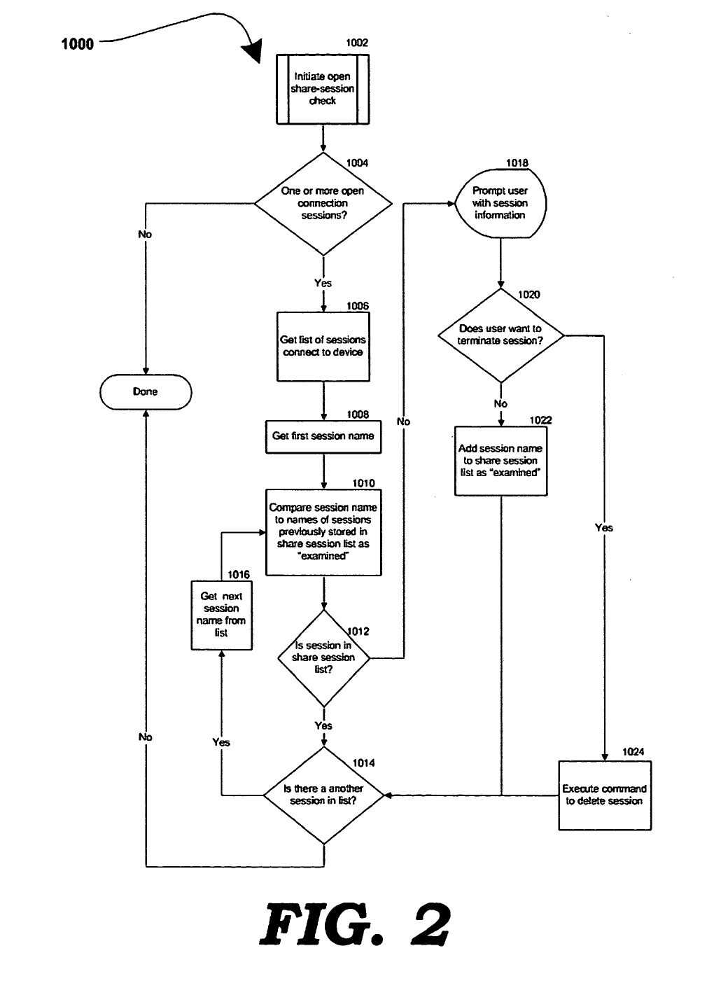

FIG. 2 illustrates a flowchart which describes one embodiment of a system operating in accordance with the present invention. Process 1002 is driven by a system-timer which queries the operating system to make a determination as to whether one or more open share-sessions 1004 are present. If one or more share-sessions are present, step 1006 obtains a list of all such open share-sessions. Step 1008 extracts the name of the first open share-session from list obtained in step 1006. Step 1010 compares the name of the session obtained in step 1008 with names of all sessions previously identified and now stored in memory.

If the current open share-session is determined to be in memory by step 1012, it is assumed the user had already had a chance to okay this session, and so step 1014 determines whether there is another session to be examined in list of open share-sessions obtained in step 1006. If step 1014 determines there is another session to be examined, step 1016 obtains the next open share-session's name and step 1010 is repeated for the new open share-session name obtained in step 1014. Once step 1012 determines a given open share-session's name is not in memory, step 1018 alerts the user with the specifics of the current open share-session in step 1010. Such alert may include the name of the remote device owning the share-session, as well as the specific files and/or folders on the local device which are being accessed via this share-session and the name of the user on the local device under whose credentials the share-session is conducted.

As part of alert 1018, the user may be presented with an option as to whether to “okay” or terminate the current share-session. If the user chooses to “okay” this share-session in step 1020, the name of this share-session is added to the application's memory for future reference in step 1010. If the user chooses to terminate this share-session in step 1020, step 1024 issues a command to the operating system of the client device to delete the current share-session. Step 1014 is then repeated until all open share-sessions obtained in step 1006 have been examined.

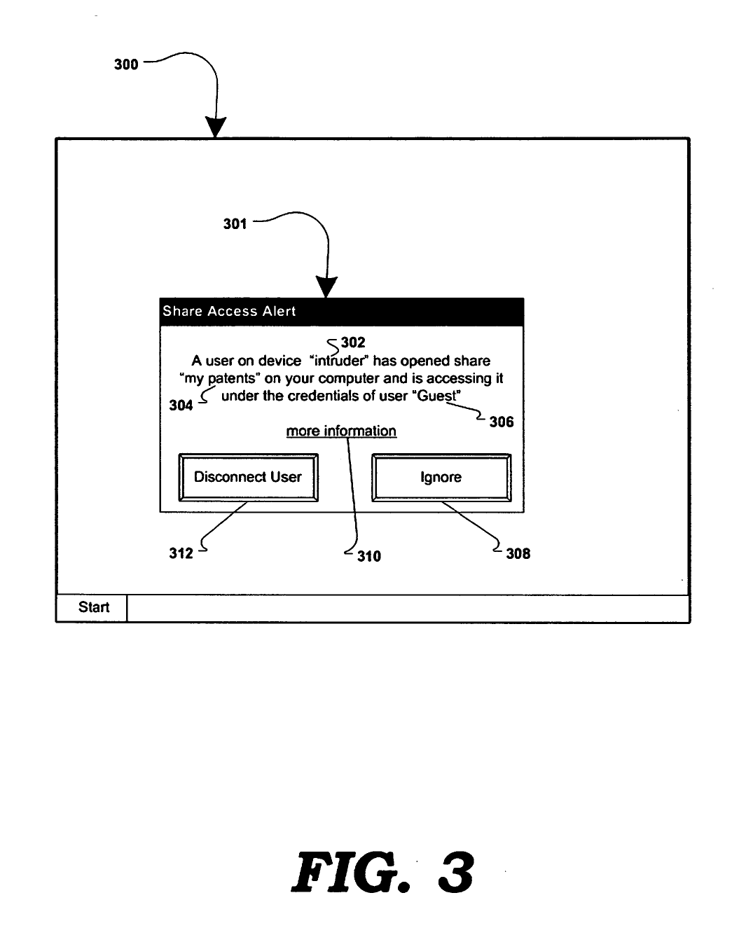

FIG. 3 is a generalized block diagram illustrating an alert message displayed to a user in response to the detection of a file-share session, in one preferred embodiment. Display area 300 (e.g. a Microsoft Window® desktop, a smart phone's desktop or the desktop of any other electronic client device) may display an alert window 301 indicating to the user the existence of an open share-session on their client device. Alert 301 includes the name of the remote device 302 owning the current open share-session, as well as the name of the folder 304 being accessed and the name of the user 306 on the local client device, whose credentials are being used to facilitate this open share-session. Additional information may be made available to the user by clicking on link 310. In other embodiments of the current invention, additional information may be presented to the user via any other audio or visual means, as available on the client device.

Alert window 301 may also include a button 312 to terminate the current open share-session and a button 308 to “ok” the current open share-session (e.g. labeled “ignore”). Button 312 sends an instruction to the operating system to terminate the current open share-session alluded to by alert window 301. (The functionality to terminate/delete/drop/close an open share-session is built into all operating systems and would result in an error occurring on the remote device owning this connection, indicating to the user on that remote device, that the folders and/or files this connection has given the remote device access to, have become inaccessible.) “Ignore” button 308 indicates the user of the client device has consented to the present open share-session, and that alert window 301 should no longer be displayed in the future to alert to the presence of this specific open share-session.

This functionality is accomplished by adding the name of this specific open share-session to the client device's memory maintained by the client-sided application. In that manner, the next time the client-sided application would detect the presence of the specific open share-session—previously Okayed by the user and recorded in memory—alert window 301 will not be displayed.

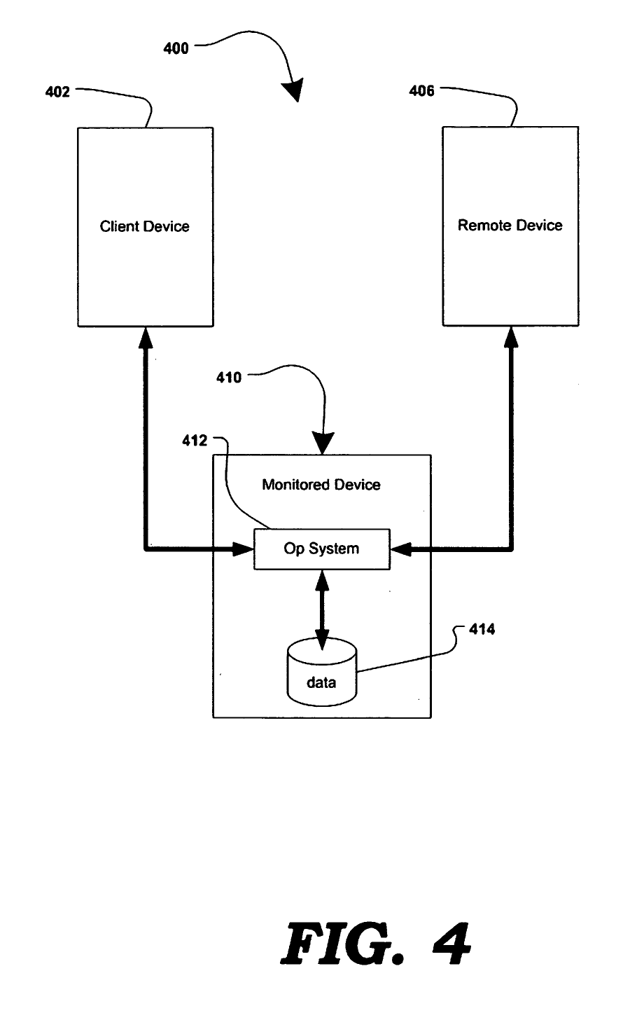

FIG. 4 is a generalized block diagram illustrating monitoring storage associated with a monitored device by a client device, according to one embodiment of the present invention. A client device 402 may be any device capable of accessing remote data over any type of network (e.g. a computer, mobile device such as a smart phone, a game console, etc.)

A monitored device 410 may be any electronic device capable of (1) storing data and (2) sharing the stored data over a network. Examples of monitored devices are PCs, SANs, NASs, game consoles, mobile devices, digital video recorders, external hard drives, DVD players, USB storage etc.

The monitored device 410 may contain an operating system (“OS”) 412 allowing for—in addition to other common OS functionality—communication with other networked devices 402 and 406. The OS 412 may also allow access to data 414 stored on the monitored device 410. The OS 412 may also allow other networked devices 402 and 406 to access the data 414.

The client device 402 may establish communication with the OS 412 of the monitored device 410 and request to monitor remote access to the data 414 managed by the OS 412. Various methods and embodiments for facilitating such request exist and are discussed throughout this document.

A remote device 406 (any device capable of electronic communication and file access, e.g. a computer, mobile device such as a smart phone etc.) may establish communication with the monitored device 410.

The remote device 406 may request from the OS 412 of the monitored device 410 to access the data 414 on the monitored device 410. As matter of common practice, the OS 412 may authenticate the user rights and/or device-rights of the remote device 406 before allowing access to the data 414, as disclosed in various prior art.

In one preferred embodiment of the present invention, the OS 412 may deliver an electronic communication to the client device 402, informing the user of the client device 402 of the data access by the remote device 406 into the data 414.

In an alternate preferred embodiment, the OS 412 may automatically suspend the data access by the remote device 406 (i.e. making the data 414 inaccessible to the remote device 406) and deliver a message (e.g. an alert) to the user of the client device 402. The message may contain information with various specifics on the nature of the remote data access (e.g. the name of the remote device 406, the user credentials of the remote device 406, the specific subset of data, e.g. file names and folders, of the data 414 being accessed, etc.) The message may allow the user of the client device 402 to allow the data access to resume (e.g. with the user of the client device 402 pressing an “OK” button in the alert message), in response to which the data access may be resumed by the OS 412.

In various other possible embodiments other steps and components may be involved to facilitate the operation of the present invention. For example, the OS 412 may include a separate software application to handle any or all the functionality described above and attributed to the OS 412.

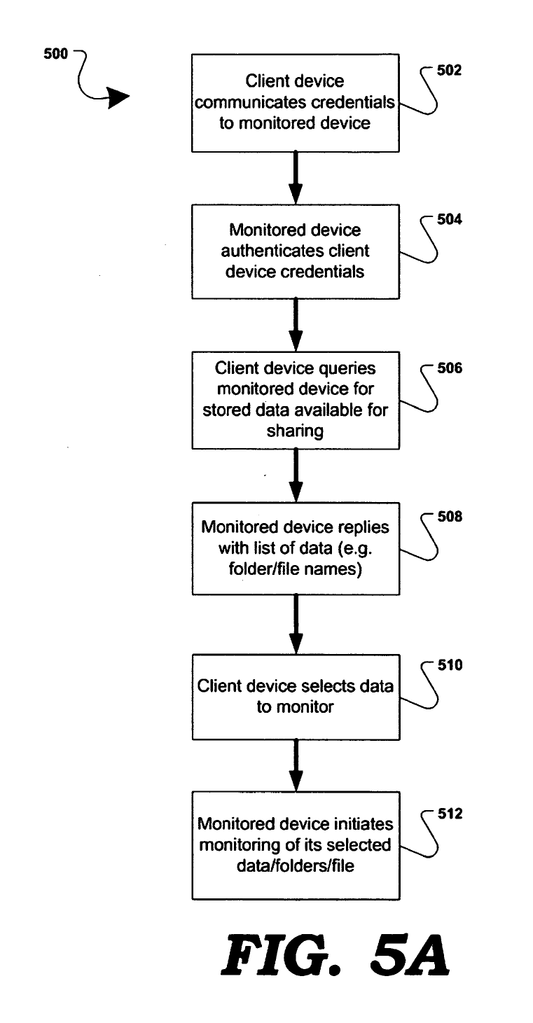

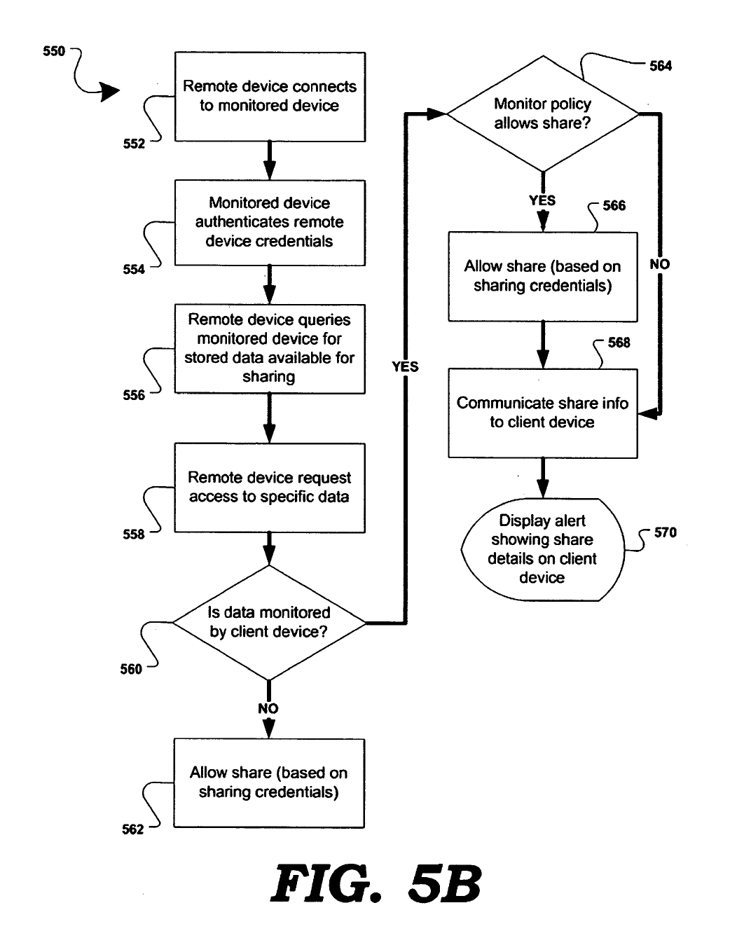

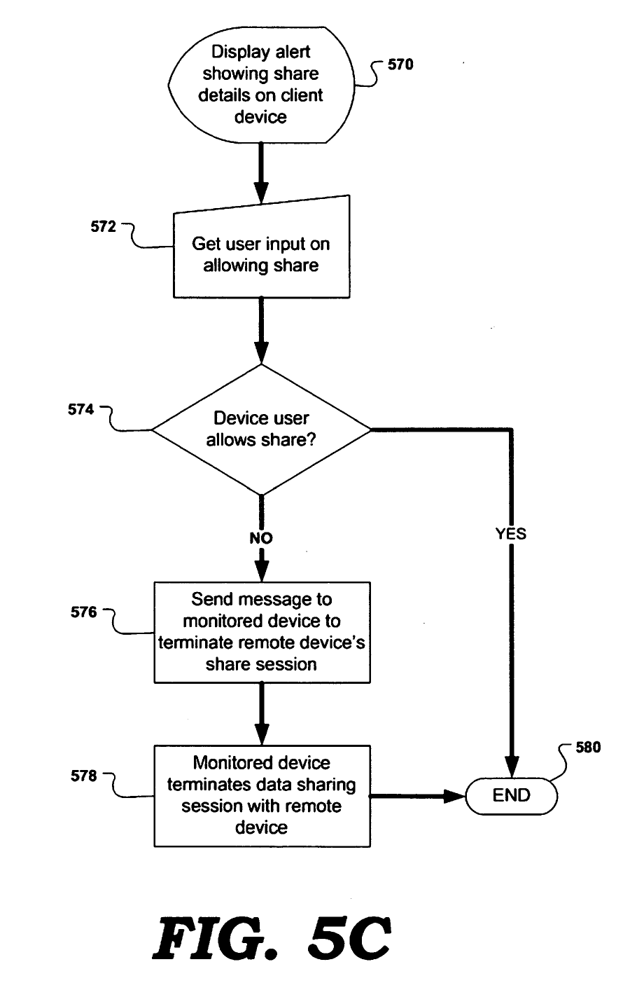

FIGS. 5A, 5B and 5C are generalized flow diagrams illustrating various ways in which a client device may interact with a monitored device to detect data access by a remote device, according to various embodiments of the present invention. The devices described herein are any electronic devices capable of any form of electronic communication, e.g. computing/telephony devices communicating over a TCP/IP network. Please note that the terms local device, managed device and remote device are used herein to differentiate devices according to their arbitrary role in this illustration, and do not imply any real difference among these devices.

Referring to FIG. 5A, flowchart 500 illustrates associating data on a monitored device with a client device, in one preferred embodiment. At step 502, a client device may transmit its credentials to a monitored device. In network-based computing it is common practice to associate user credentials with a device and transmit the credentials to remote devices to gain various levels of access. For example, a client device may require a user logon, such as user name and password, and may transmit these logon credentials to a second device (herein “managed device”). The managed devices may then authenticate the logon credentials against a local data store, a remote data store (e.g. Active Directory®) and may implement a policy determining what operations the client device may perform, and what data the client device may access, on the managed device.

At step 504, the monitored device may authenticate the credentials received from the client device and may determine an entitlement by the client device to query data on the monitored device. At step 506 the client device may query the monitored device for data stored on the monitored device (or associated with the monitored device) that is accessible over the network or by another user associated with the monitored device (e.g. media files on the monitored device accessible over the network.)

At step 508, in response to the query at step 506, the monitored device may transmit to the client device a list of the data accessible via file sharing. The data may be presented to the user of the client device in various forms, for example as a tree-hierarchy folder structure, allowing the client to drill into folder contained in the data, and determine their file contents.

At step 510, the user of the client device may select specific data to be monitored. For example, the user of the client device may select (e.g. via checking with a pointing device) names of flies or folders on the monitored device to be monitored for external file sharing access.

At step 512, the monitored device may instantiate monitoring of the selected subset of data. Monitoring may be conducted by the OS or any other software, such as services/daemon applications.

Referring now to FIG. 5B, flow diagram 550 illustrates a remote device connecting to the monitored device, requesting access to shared data and generating a response by the monitored device.

At step 552, a remote device may connect to the monitored device, for example over a network. In other examples, the remote device may be a peripheral of the monitored device.

At step 554, an authentication process may take place, facilitating the connection of the remote device to the monitored device. Authentication may require the passing and authentication of user credentials, and may involve the use of one or more layers such as firewalls, proxies, OS, Active Directory, a repository of user profiles, etc.

At step 556 the remote device may query the monitored device for accessible shared data. For example, the remote device may request a list of all files and folders on the (or associated with) the monitored device that had been designated as shareable to remote users.

At step 558 the remote device may request specific data from the data deemed shareable at step 556. Please note that steps 556 and 558 are illustrative and may be consolidated into one step; or, divided into a many granular smaller steps.

At step 560, it may be determined whether the data requested at step 558 is being monitored by the monitored device (refer to FIG. 5A, step 510 for an illustrative selection of specific subsets of data to be monitored.) If it is determined at step 560 that the specific data requested at step 558 is not monitored, at step 562 the requested data may be transmitted to the remote device (provided the remote device is entitled to access the data considering other authentication requirements outside the scope of this invention, example NTFS permissions or Active Directory profiles or file/folder permissions, etc.)

If it is determined at step 560 that the requested data is monitored, at step 564 it may be determined whether the monitoring policy (i.e. the policy set by the monitored device in conjunction with the client device) allows for the sharing requested at step 558. For example, in one preferred embodiment, sharing/data access is automatically suspended by the monitored device until the sharing is approved by the client device.

If at step 564 it is determined the policy does not restrict sharing automatically, at step 566 the remote device may gain access to the requested shares/data.

At step 568 an electronic message (e.g. alert) may be transmitted to the client device alerting of the new data access/share session. If at step 564 it is determined the policy requires automatic suspension of all new data access/share requests, step 566 may be skipped and step 568 may be invoked.

At step 570 the user of the client device may receive the message/alert informing them of the new share/data access session. The alert may be visual, contain audio, be sent to the user via a plurality of channels such as voice, electronic messages, text, etc. The alert may contain information on the specific data being accessed, the identity of the user of the remote device, etc.

Referring now to FIG. 5C, the message/alert 570 displayed to the user may be interactive, allowing the user of the client device to transmit an instruction to the monitored device to take various actions.

At step 572, user input may be collected to determine the type of action to take. For example, the user may press a button such as “terminate immediately”, or select from a list of action items; communicate a message to the user of the remote device, display an alert on the remote device, etc.

If at step 574 it is determined that the input received at step 572 indicated no adverse action to stop the share session, at step 580 no action may be taken, allowing the share to continue unabated. Please note that if the policy had automatically suspended sharing (as discussed in one ramification in FIG. 5B), following step 574 an automatic instruction may be transmitted to the monitored device resuming the data sharing session, prior to the termination of the flow at step 580.

If it is determined at step 574 that the user input at step 572 had requested the termination of the data share session on the monitored device, at step 576 an electronic message may be transmitted to the monitored device to terminate the shared session.

At step 578, the monitored device may terminate the share session, i.e. prohibiting any further access to the data by the remote device. For example, in a home environment, a child (i.e. remote user) may request access to a movie on a storage device (i.e. monitored device) and, after standard user authentication; the movie may start transmitting to the child's remote device. The parent (i.e. client device) may receive an immediate alert on their own device specifying their child is downloading a specific movie from the storage device. The parent's alert may display a button such as “suspend access”, which the parent may press, causing the storage device to suspend the transmission of the movie to the child's remote device.

In alternate possible embodiments, various different methods may be used to implement the present invention, along the generalized outline in FIGS. 5A-5C, involving various software, networking and hardware components.

While various embodiments of the present invention have been described in detail, it is apparent that further modifications and adaptations of the present invention will occur to those skilled in the art. However, it is to be expressly understood that such modifications and adaptations are within the spirit and scope of the present invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A system for protecting files against unauthorized access, wherein said system comprises an application executed by a computer within a network of computers and wherein, when executed by the computer, said application is configured to cause said system to:
Monitor file access operations of a plurality of files, wherein each of said plurality of files is subject to being shared between at least two users, wherein said file access operations are initiated by at least one of said users, and wherein each of said users has a set of privileges associated therewith;
When at least one access operation of a shared file is determined to exist, retrieve identifying information of a remote device associated with the file access operation and log at least one privilege assigned to the user associated with the detected file access operation;
Determine whether the file access operation of the shared file is permissible; and
In the event the file access operation of the shared file is not permissible, send an alert, wherein the alert includes the identifying information of the remote device.

40. The system of claim 39 wherein said application further causes said system to transmit an approval request to a recipient of the alert.

41. The system of claim 40 wherein, in response to receiving an approval from said recipient, store that the file access operation of the shared file by said user is permissible.

42. The system of claim 40 wherein, in response to receiving a denial from said recipient, terminate said file access operation of the shared file by said user.

43. The system of claim 40 wherein, in response to receiving a denial from said recipient, store that the file access operation of the shared file by said user is not permissible.

44. The system of claim 39 wherein each of the shared files is associated with at least one folder.

45. The system of claim 44 wherein the at least one folder is designated as being subject to sharing between the users.

46. The system of claim 39 wherein said identifying information of a remote device includes an internet protocol (“IP”) address of said remote device.

47. The system of claim 39 wherein said identifying information of a remote device includes a name of said remote device.

48. The system of claim 39 wherein the alert includes identifying information specifying the shared file associated with the access operation which is determined not to be permissible.

49. The system of claim 39 wherein the access operation is determined not to be permissible by comparing identifying information of the access operation with a share session list.

50. The system of claim 39 wherein the access operation is determined to be permissible by comparing identifying information of the access operation with a share session list.

51. The system of claim 39 wherein, in the event the alert is sent, log a denial or approval received in response to the alert.

52. The system of claim 39 wherein the monitoring of file access operations of a plurality of files is initiated by a timer.

53. The system of claim 52 wherein the timer is operated at a frequency of greater than 1 cycle per second.

54. The system of claim 39 wherein the monitoring of file access operations of a shared file is invoked upon detection of access to the shared file associated with a selected electronic device.

55. The system of claim 39 wherein, in the event the alert is sent, log information, said information including identifying information about the file associated with the access operation, the user associated with the access operation, and the remote device associated with the access operation.

56. The system of claim 39 wherein the alert is sent to a remote device and displayed on a screen, wherein said displayed alert comprises at least one of identifying information about the file associated with the access operation, the user associated with the access operation, or the remote device associated with the access operation.

57. A system for protecting files against unauthorized access, wherein said system comprises an application executed by a computer within a network of computers and wherein, when executed by the computer, said application is configured to cause said system to:
Monitor a file access operation of a file, wherein said file is subject to being shared between at least two users, wherein said file access operation is initiated by at least one of said users, and wherein each of said users has a set of credentials associated therewith;
When the access operation of the shared file is determined to exist, retrieve identifying information of a remote device associated with the file access operation and log at least one credential assigned to said at least one user associated with the detected file access operation;
Determine whether the file access operation of the shared file is permissible;
In the event the file access operation of the shared file is not permissible, send an alert, wherein the alert includes the identifying information of the remote device; and
In the event the alert is sent, log information, said information including at least one of identifying information about the file associated with the access operation, the user associated with the access operation, or the remote device associated with the access operation.

58. A system for protecting files against unauthorized access, wherein said system comprises an application executed by a computer within a network of computers and wherein, when executed by the computer, said application is configured to cause said system to:
Monitor a file access operation of a file, wherein said file is associated with a folder that is subject to being shared between at least two users, and wherein said file access operation is initiated by at least one of said users;
When the access operation of the shared file is determined to exist, retrieve an internet protocol (“IP”) address of a remote device associated with the file access operation and log at least one credential assigned to said at least one user associated with the detected file access operation;
Determine whether the file access operation of the shared file is permissible;
In the event the file access operation of the shared file is not permissible, send an alert, wherein the alert includes the identifying information of the remote device; and
In the event the alert is sent, log information, said information including identifying information about the file associated with the access operation and identifying information about the user associated with the access operation.

59. The system of claim 58 wherein said identifying information of a remote device includes an internet protocol (“IP”) address of said remote device.
